(19) United States
(12) Patent Application Publication
(10) Pub. No.: US 2026/0015005 A1
(43) Pub. Date: Jan. 15, 2026

(54) VEHICLE

(71) Applicant: TOYOTA JIDOSHA KABUSHIKI KAISHA, Toyota-shi (JP)

(72) Inventors: Ruiko ITO, Nisshin-shi (JP); Miki NOMOTO, Nagoya-shi (JP); Kenichi YAMADA, Nisshin-shi (JP); Hirohito IDE, Nagoya-shi (JP)

(73) Assignee: TOYOTA JIDOSHA KABUSHIKI KAISHA, Toyota-shi (JP)

(21) Appl. No.: 19/235,655

(22) Filed: Jun. 12, 2025

(30) Foreign Application Priority Data
Jul. 4, 2024 (JP) 2024-108155

(51) Int. Cl. B60W 50/14; B60W 50/02; B60W 50/029; B60W 60/00

(52) U.S. Cl. CPC B60W 50/14; B60W 50/0205; B60W 50/029; B60W 60/001; B60W 2050/143; B60W 2050/146

(57) ABSTRACT

When an ADK is mounted on a vehicle and a unit authentication for the ADK is completed, a VCIB performs a process including a step of determining whether an anomaly is occurring in a communication with the ADK, a step of notifying, when the vehicle is in an autonomous driving mode and an anomaly is determined to be occurring in the communication with the ADK, occurrence of an anomaly in an autonomous driving system, and a step of notifying, when the vehicle is in a manual operation mode and an anomaly is determined to be occurring in the communication with the ADK, that the use of the autonomous driving system is not allowed.

### CROSS REFERENCE TO RELATED APPLICATIONS

This nonprovisional application is based on Japanese Patent Application No. 2024-108155 filed on Jul. 4, 2024 with the Japan Patent Office, the entire contents of which are hereby incorporated by reference.

### BACKGROUND

### Field

The present disclosure relates to a vehicle.

### Description of the Background Art

In recent years, autonomous driving systems for allowing a vehicle to travel, without receiving user operations are being developed. For example, in order to allow the autonomous driving system to be mounted on an existing vehicle, the autonomous driving system may be provided separately from the vehicle via an interface.

As such an autonomous driving system, for example, Japanese Patent Laying-Open No. 2018-132015 discloses a technique to add the autonomous driving feature to an existing vehicle, without requiring significant changes to the vehicle, by providing a control device for managing mechanical power of the vehicle and a control device for the autonomous driving independent of each other.

### SUMMARY

In the vehicle having the autonomous driving system as described above mounted thereon, a communication anomaly may occur between the autonomous driving system and the vehicle. In the event of a communication anomaly during autonomous driving, the autonomous driving cannot continue after the occurrence of the anomaly. In the event of a communication anomaly during manual driving, in contrast, the manual driving can continue. Therefore, notifying the same information to the user uniformly in the event of a communication anomaly may not provide appropriate information to the user.

An object of the present disclosure is to provide a vehicle that notifies a user of appropriate information in the event of a communication anomaly with an autonomous driving system.

A vehicle according to a certain aspect of the present disclosure includes: an autonomous driving system; a vehicle platform that performs a vehicle control, according to a command from the autonomous driving system; and a vehicle control interface that interfaces between the vehicle platform and the autonomous driving system, wherein in an event of an anomaly in a communication between the autonomous driving system and the vehicle control interface during autonomous driving of the vehicle, the vehicle control interface notifies a user of first information, and in an event of an anomaly in the communication during manual driving of the vehicle, the vehicle control interface notifies the user of second information different from the first information.

In this way, in the event of a communication anomaly with the autonomous driving system, the user is notified of different information during autonomous driving and during manual driving, thereby notifying the user of appropriate information upon the communication anomaly during autonomous driving and upon the communication anomaly during manual driving, respectively.

In a certain embodiment, when the autonomous driving system is not mounted on the vehicle, the vehicle control interface does not determine whether an anomaly has occurred in the communication.

In this way, a determination, due to the vehicle not having the autonomous driving system mounted thereon that a communication anomaly has occurred and providing the user with such a notification, can be reduced.

In another embodiment, when a unit authentication for the autonomous driving system mounted on the vehicle is not completed, the vehicle control interface does not determine whether an anomaly has occurred in the communication, and when the unit authentication is completed, the vehicle control interface determines whether an anomaly has occurred in the communication.

In this way, a determination, due to the unit authentication being not completed, that a communication anomaly has occurred and providing the user with such a notification, can be reduced.

In still another embodiment, the first information includes information indicating that an anomaly has occurred in the autonomous driving system, and the second information includes information indicating that use of the autonomous driving system is not allowed.

In this way, during the autonomous driving, the user is notified of the information indicating that an anomaly has occurred in the autonomous driving system, and the user is, therefore, allowed to recognize that the autonomous driving cannot continue. During the manual driving, the user is notified of the information indicating that the use of the autonomous driving system is not allowed, and the user is, therefore, allowed to recognize, during the manual driving, that the manual driving cannot be switched to the autonomous driving.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing an overview of a vehicle according to an embodiment of the present disclosure.

FIG. 2 is a diagram for illustrating details of respective configurations of an ADS, a VCIB, and a VP.

FIG. 3 is a flowchart illustrating one example of a process performed by the VCIB.

FIG. 4 is a diagram for illustrating one example of an operation of the VCIB.

### DESCRIPTION OF THE PREFERRED EMBODIMENT

Hereinafter, an embodiment according to the present disclosure will be described in detail, with reference to the accompanying drawings. Note that the same reference sign is used to refer to the same or like parts, and the description thereof will not be repeated.

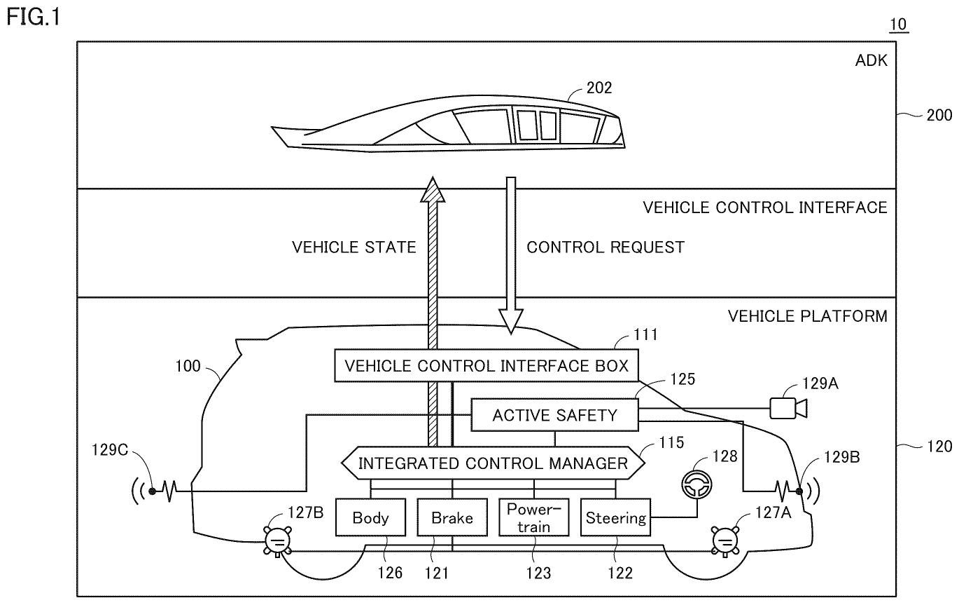

FIG. 1 is a diagram showing an overview of a vehicle 10 according to an embodiment of the present disclosure. Referring to FIG. 1, vehicle 10 includes an autonomous driving kit (hereinafter, denoted as “ADK”) 200, and a vehicle platform (hereinafter, denoted as “VP”) 120. ADK 200 and VP 120 are communicably connected to each other via a vehicle control interface.

Vehicle 10 can perform autonomous driving according to a control request (a command) from ADK 200 mounted on VP 120. Note that while FIG. 1 shows VP 120 and ADK 200 located away from each other, ADK 200, in practice, is mounted on the roof top or the like of a base vehicle 100. ADK 200 is detachable from VP 120. When ADK 200 is detached from VP 120, VP 120 performs a driving control in a manual operation mode (a driving control according to a user operation).

ADK 200 includes an autonomous driving system (hereinafter, denoted as “ADS”) 202 for performing the autonomous driving of vehicle 10. For example, ADS 202 creates a travel schedule for vehicle 10 and outputs, to VP 120 according to an application program interface (API), various commands (control requests) for allowing vehicle 10 to travel according to the travel schedule. ADS 202 also receives various signals indicating states of VP 120 (a vehicle state) from VP 120 according to an API defined for each signal, and reflects the vehicle state to the creation of the travel schedule.

VP 120 includes base vehicle 100, and a vehicle control interface box (hereinafter, denoted as a “VCIB”) 111 for implementing the vehicle control interface provided within base vehicle 100.

VCIB 111 is communicable with ADK 200 via a controller area network (CAN) or the like. VCIB 111 performs a predetermined API, defined for each signal communicated, to receive various commands from ADK 200 and outputs a state of VP 120 to ADK 200. In other words, upon receiving a control request from ADK 200, VCIB 111 outputs a control command, corresponding to the control request, to a system corresponding to the control command via an integrated control manager 115. VCIB 111 also obtains various information on base vehicle 100 from various systems via integrated control manager 115 and outputs a state of base vehicle 100 to ADK 200 as the vehicle state.

VP 120 includes various systems and various sensors for controlling base vehicle 100. As VP 120 performs various vehicle controls according to control requests from ADK 200 (specifically, ADS 202), the autonomous driving of vehicle 10 is performed. For example, VP 120 includes a brake system 121, a steering system 122, a powertrain system 123, an active safety system 125, and a body system 126.

Brake system 121 is configured to control multiple braking devices that are each provided for respective wheels of base vehicle 100. For example, the braking devices include a disc brake system that operates using hydraulic power tuned by an actuator. For example, brake system 121 is connected to wheel-speed sensors 127A and 127B. For example, wheel-speed sensor 127A is provided for a front wheel of base vehicle 100 to detect the rotational velocity of the front wheel. Wheel-speed sensor 127A outputs the rotational velocity of the front wheel to brake system 121. For example, wheel-speed sensor 127B is provided for a rear wheel of base vehicle 100 to detect the rotational velocity of the rear wheel. Wheel-speed sensor 127B outputs the rotational velocity of the rear wheel to brake system 121. Wheel-speed sensors 127A and 127B output a pulse signal as an output value (a pulse value). The rotational velocity is calculated using the number of pulses in the pulse signal. Brake system 121 outputs the rotational velocity of each wheel to VCIB 111, as a piece of information included in the vehicle state.

Brake system 121 generates a braking command for a braking device, according to a predetermined control request output from ADK 200 via VCIB 111 and integrated control manager 115, and controls the braking device using the braking command.

Steering system 122 is configured to control the steering wheel angle of a steering wheel of vehicle 10 using a steering device. For example, the steering device includes a rack and pinion electric power steering (EPS) that can adjust the steering wheel angle by an actuator.

Steering system 122 is connected to a pinion angle sensor 128. Pinion angle sensor 128 detects the angle of rotation (a pinion angle) of the pinion gear coupled to a rotation shaft of the actuator included in the steering device. Pinion angle sensor 128 outputs the pinion angle to steering system 122. Steering system 122 outputs the pinion angle to VCIB 111, as a piece of information included in the vehicle state.

Powertrain system 123 controls an electric parking brake (EPB) provided for at least one of the wheels of vehicle 10, a parking lock (hereinafter, described as a P-Lock) device provided for the transmission of vehicle 10, a shift device configured to select any one of multiple shift ranges, and a drive source of vehicle 10.

Active safety system 125 uses a camera 129A and radar sensors 129B and 129C to detect an obstacle and so on (an obstacle or a human) in front of or behind vehicle 10. If there is a likelihood of a collision with the obstacle depending on a distance to the obstacle or a direction of movement of vehicle 10, active safety system 125 outputs a braking command to brake system 121 via integrated control manager 115 so that the braking force is increased.

For example, body system 126 is configured to control parts such as a directional indicator, a horn, or a windshield wiper, depending on a traveling state or traveling environment of vehicle 10. Body system 126 controls the above parts according to predetermined control requests output from ADK 200 via VCIB 111 and integrated control manager 115.

Note that the vehicle 10 can be employed as a part of the configuration of a Mobility as a Service (MaaS) system. In addition to vehicle 10, the MaaS system further includes, for example, a data server, a mobility service platform (MSPF), and mobility services (none of which are shown) related to the autonomous driving.

Vehicle 10 further includes a data communication module (DCM) (not shown) as a communications interface (I/F) for wireless communications with the data server. For example, the DCM outputs various pieces of vehicle information such as a speed, a location, and an autonomous driving state to the data server. The DCM also receives, from mobility services through the MSPF and the data server, various data for managing the travel of automated vehicles, including vehicle 10, in the mobility services related to the autonomous driving, for example.

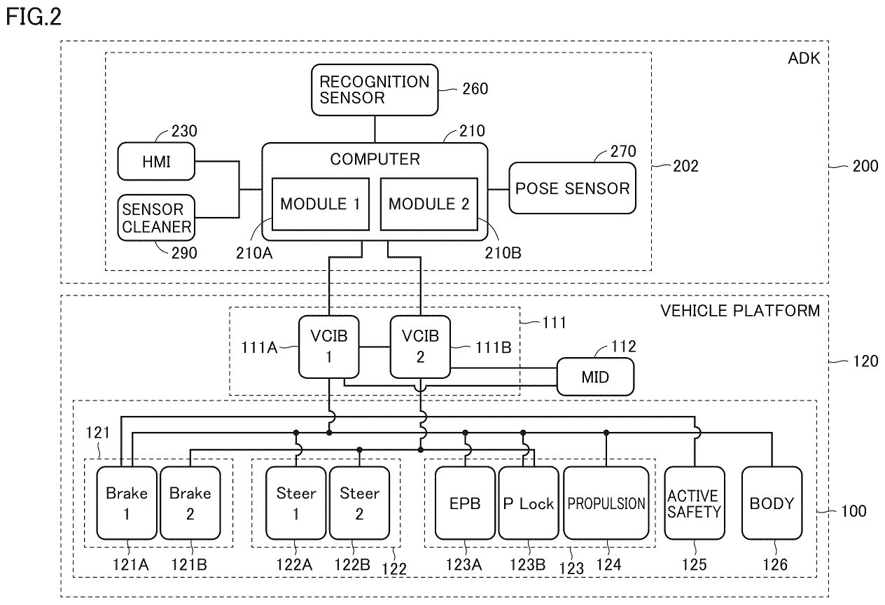

FIG. 2 is a diagram for illustrating details of respective configurations of ADS 202, VCIB 111, and VP 120. As shown in FIG. 2, ADS 202 includes a computer assembly (hereinafter, “CA”) 210, a human machine interface (HMI) 230, a recognition sensor 260, a pose sensor 270, and a sensor cleaner 290.

During the autonomous driving of vehicle 10, CA 210 uses various sensors (described below) to obtain environment around the vehicle 10, the pose, behavior, and location of the vehicle 10, obtains the vehicle state from VP 120 (described below) via VCIB 111, and sets the next operation of vehicle 10 (such as accelerating, decelerating, or making a turn). CA 210 outputs various commands for implementing the set next operation of vehicle 10 to VCIB 111. CA 210 includes computer modules (hereinafter, “ADC”) 210A and 210B for the autonomous driving. ADCs 210A and 210B are each communicable with VCIB 111.

HMI 230 presents information to the user or receives operations, during the autonomous driving, during driving requiring user operations, and during a transition between the autonomous driving and the driving requiring user operations. For example, HMI 230 is connectable to a touch panel display or an I/O device such as a display device and operating equipment, which are provided in base vehicle 100.

Recognition sensor 260 includes a sensor for recognizing the environment around vehicle 10, the sensor being configured of, for example, at least one of a LIDAR (Laser Imaging Detection and Ranging), a millimeter wave radar, and a camera.

The LIDAR is a distance meter device which emits laser light (infrared) in the form of pulses to measure the distance to an object by the time taken for the lase light to reflect from the object back to the distance meter device. The millimeter wave radar is a distance meter device which emits a radio wave having a short wavelength to an object to detect the radio wave back from the object and measure the distance or direction to the object. For example, the camera is disposed on the backside of the rear view mirror inside the vehicle compartment and used to capture an image of the front of the vehicle. The information obtained by recognition sensor 260 is output to CA 210. An image or a video captured by the camera is subjected to image processing using artificial intelligence (AI) or an image processing processor to allow recognition of other vehicle, an obstacle, or a person in front of the vehicle 10.

Pose sensor 270 includes a sensor for detecting the pose, behavior, or location of the vehicle 10, which is configured of, for example, an inertial measurement unit (IMU) or a global positioning system (GPS).

For example, the IMU detects accelerations of the vehicle 10 in the front-rear direction, the left-right direction, and the up-down direction, and angular velocities in the roll direction, the pitch direction, and the yaw direction of the vehicle 10. The GPS detects the location of vehicle 10, using information received from multiple GPS satellites orbiting around the Earth. The information obtained by pose sensor 270 is output to CA 210.

Sensor cleaner 290 is configured to remove soils that stick to various sensors while the vehicle 10 is traveling. For example, sensor cleaner 290 removes the soils on the camera lens, laser or radio wave irradiators or the like, with a cleaning fluid, a windshield wiper, etc.

VCIB 111 includes a VCIB 111A and a VCIB 111B. VCIB 111A and VCIB 111B have a central processing unit (CPU) and memories (e.g., including a read only memory (ROM), a random access memory (RAM), etc.) (which are not shown) incorporated therein. VCIB 111A has functions equivalent to those of VCIB 111B, but is connected to systems constituting VP 120, which are partially different from those the VCIB 111B is connected to.

VCIB 111A and VCIB 111B are communicatively connected to ADC 210A and ADC 210B, respectively, of CA 210. Furthermore, VCIB 111A and VCIB 111B are communicatively connected to each other.

VCIB 111A and VCIB 111B each relay and output a command corresponding to a control request from ADS 202 to a corresponding system included in VP 120, as a control command. More specifically, VCIB 111A and VCIB 111B each use a command, output from ADS 202 using information (e.g., API) such as a program stored in a memory, to generate and output a control command, which is used to control a corresponding system included in VP 120, to the corresponding system. VCIB 111A and VCIB 111B each also relay and output vehicle information output from each system of VP 120 to ADS 202, as the vehicle state. Note that the information indicating the vehicle state may be the same information as the vehicle information or information that is extracted from the vehicle information to use in a process performed by ADS 202.

As vehicle 10 includes VCIB 111A and VCIB 111B that have the same function over the operations of some systems (e.g., the brake or the steering), the control system for ADS 202 and the control system for VP 120 are redundant. Therefore, the function of VP 120 (such as turning or stop) can be maintained by switching the control systems as appropriate in the event of a failure in some system, or by blocking a failed control system.

Brake system 121 includes brake systems 121A and 121B. Steering system 122 includes steering systems 122A and 122B. Powertrain system 123 includes an EPB system 123A, a P-Lock system 123B, and a propulsion system 124. Among the systems included in VP 120, brake system 121A, steering system 122A, EPB system 123A, P-Lock system 123B, propulsion system 124, and body system 126 and VCIB 111A are communicatively connected to each other via a communication bus. Among the systems included in VP 120, brake system 121B, steering system 122B, and P-Lock 123B and VCIB 111B are communicatively connected to each other via a communication bus.

VCIB 111 is connected to a multi information display (MID) 112. MID 112 is a display device for the odometer, the tripmeter, outdoor air temperature display, various information such as maintenance, or a notification or a request to the user, etc. For example, MID 112 is provided at a location (e.g., around the steering wheel) viewable to the user sitting in the vehicle compartment. MID 112 displays various information, including text information and/or image information, according to a display command from VCIB 111 (specifically, at least any one of VCIB 111A and VCIB 111B). For example, MID 112 may display various information according to a display command from ADS 202 via VCIB 111.

Brake systems 121A and 121B are configured to control multiple braking devices provided for respective wheels of the vehicle 10. Brake system 121A may have a function equivalent to brake system 121B or have a function different from brake system 121B. Brake systems 121A and 121B generate braking commands for braking devices, according to control requests output from ADS 202 via VCIB 111A and VCIB 111B, respectively. One brake system, among brake systems 121A and 121B, is used to control a braking device, and the other brake system, among brake systems 121A and 121B, is used to control the braking device in the event of an anomaly of the one brake system.

Steering systems 122A and 122B are each configured to control the steering wheel angle of a steering wheel of vehicle 10, using the steering device. Steering system 122A and steering system 122B have the same function.

Steering systems 122A and 122B each generate a steering command for the steering device according to a control request output from ADS 202 via VCIB 111A and VCIB 111B, respectively. One steering system, among steering systems 122A and 122B, is used to control the steering device and the other steering system, among steering systems 122A and 122B, is used to control the steering device in the event of an anomaly of the steering system.

EPB system 123A is configured to control the EPB. The EPB locks the wheels by the operation of the actuator. EPB system 123A controls the EPB, according to a control request output from ADS 202 via VCIB 111A.

P-Lock system 123B is configured to control the P-Lock device. P-Lock system 123B controls the P-Lock device, according to control requests output from ADS 202 via VCIB 111A. For example, if the control requests, output from ADS 202 via VCIB 111A, include a control request for switching the shift range to the parking range (hereinafter, described as a P range), P-Lock system 123B activates the P-Lock device. If the control requests include a control request for switching the shift range to a range, other than the P range, P-Lock system 123B deactivates the P-Lock device.

Propulsion system 124 is configured to switch the shift ranges using the shift device and control the driving force of vehicle 10 for the direction of movement of vehicle 10 using the drive source. Examples of the shift ranges include the P range, a neutral range (hereinafter, described as an N range), a forward travel range (hereinafter, described as a D range), and a reverse travel range (hereinafter, described as an R range). Examples of the drive source include a motor generator and an engine.

Propulsion system 124 controls the shift device and the drive source, according to control requests output from ADS 202 via VCIB 111A. For example, if the control requests output from ADS 202 via VCIB 111A include a control request for switching the shift range to the P range, propulsion system 124 controls the shift device so that the shift range switches to the P range.

Active safety system 125 is communicatively connected to brake system 121A. As described above, active safety system 125 uses camera 129A and radar sensor 129B to detect an obstacle (an obstacle or a human) in front of vehicle 10, and if determined that there is a likelihood of a collision with the obstacle based on the distance to the obstacle, output a braking command to brake system 121A so that the braking force is increased.

Body system 126 controls parts such as the directional indicator, the horn or the windshield wiper, etc., according to control requests output from ADS 202 via VCIB 111A.

Note that operating equipment for the user to manually operate the above-described braking device, steering device, EPB, P-Lock device, shift device, the drive source, and so on, are separately provided.

Examples of the various commands in response to the control requests output from ADS 202 to VCIB 111 include a propulsion direction command requesting for a shift range switch, an immobilization command requesting for activation or deactivation of the EPB to the P-Lock device, an acceleration command requesting for acceleration or deacceleration of vehicle 10, a tire-turning-angle command requesting for a tire turning angle for the steering wheel, a vehicle mode command for switching a vehicle mode state between the autonomous driving mode and the manual mode, and a stop command for requesting for a vehicle stop retention or cancellation of the vehicle stop retention.

As the autonomous driving mode is selected as the vehicle mode state, for example, through a user operation on HMI 230 in vehicle 10, the autonomous driving is implemented. As noted above, ADS 202 creates a travel schedule during the autonomous driving. The travel schedule includes multiple schedules regarding the operations of vehicle 10, such as a schedule to continue to travel straight, a schedule to turn left or right at a predetermined crossing on the way of a predetermined travel route, or a schedule for a lane change.

ADS 202 extracts controlling physical quantities (e.g., the acceleration or deceleration or a tire turning angle, etc.) required for vehicle 10 to operate along the created travel schedule. ADS 202 divides the physical quantities for each API execution cycle. Using the divided physical quantities, ADS 202 executes the API to output various commands to VCIB 111. Furthermore, ADS 202 obtains the vehicle state (e.g., the actual direction of movement of vehicle 10 or a stationary state of the vehicle) from VP 120 and re-creates a travel schedule reflecting the vehicle state. In this way, ADS 202 enables the autonomous driving of vehicle 10.

In contrast, for example, as the manual operation mode is selected as the vehicle mode through user operations on HMI 230 in vehicle 10, the manual driving is enabled. In this case, vehicle 10 is operated through user operations on the operating equipment.

In vehicle 10 having ADK 200 mounted thereon as described above, a communication anomaly may occur between ADK 200 and VP 120. In the event of a communication anomaly during autonomous driving, the autonomous driving cannot continue after the occurrence of the anomaly. In the event of a communication anomaly during manual driving, in contrast, the manual driving can continue. Therefore, notifying the same information to the user uniformly in the event of a communication anomaly may not provide appropriate information to the user.

Thus, in the present embodiment, in the event of a communication anomaly between ADK 200 and VCIB 111 during the autonomous driving, VCIB 111 notifies the user of first information. In the event of the communication anomaly during manual driving, VCIB 111 notifies the user of second information different from the first information. The first information includes information indicating that an anomaly has occurred in the autonomous driving system. The second information includes information indicating that the use of the autonomous driving system is not allowed.

In this way, in the event of a communication anomaly between ADK 200 and VCIB 111, the user is notified of different information during autonomous driving and during manual driving, thereby notifying the user of appropriate information upon the communication anomaly during autonomous driving and upon the communication anomaly during manual driving, respectively.

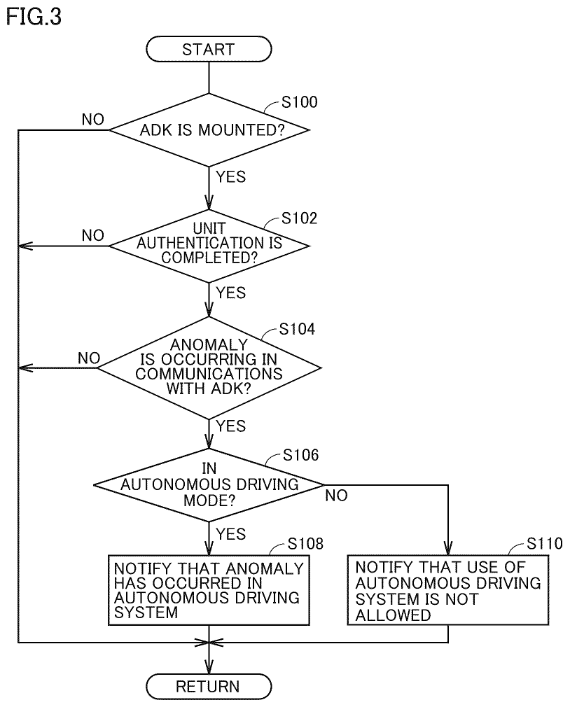

In the following, referring to FIG. 3, a process performed by VCIB 111 (more specifically, VCIB 111A or VCIB 111B) is described. FIG. 3 is a flowchart illustrating one example of the process performed by VCIB 111. VCIB 111 repeatedly performs a process as follows, for each API execution cycle, for example.

In step (hereinafter, described as S) 100, VCIB 111 determines whether ADK 200 is mounted on vehicle 10. VCIB 111 determines that the ADK 200 is mounted on vehicle 10, for example, if VCIB 111 receives a predetermined signal (various commands) from ADK 200 or receives an on-signal from a switch, which physically turns on at a moment the ADK 200 is mounted on vehicle 10. For example, if VCIB 111 receives no signal from ADK 200 or the switch, VCIB 111 determines that the vehicle 10 is devoid of ADK 200. If vehicle 10 is determined as having ADK 200 mounted thereon (YES in S100), the process proceeds to S102.

In S102, VCIB 111 determines whether the unit authentication for ADK 200 mounted on vehicle 10 is completed. VCIB 111 determines whether the unit authentication is completed, for example, based on a flag, which is set to on at a moment the unit authentication process for ADK 200 is completed. A well-known technique may be used for the unit authentication process and detailed description will not be provided. If the unit authentication for ADK 200 is determined to be completed (the flag is on) (YES in S102), the process proceeds to S104.

In S104, VCIB 111 determines whether an anomaly is occurring in the communication with ADK 200. If VCIB 111A does not receive the various signals from ADC 210A for a predetermined period of time, VCIB 111 determines that the communication with ADC 210A is anomalous. In this case, VCIB 111B attempts to communicate with ADC 210B. Then, if VCIB 111B does not receive the various signals from ADC 210B for a predetermined period of time, VCIB 111 determines that the communication with ADC 210B is anomalous. If the communication with ADC 210A and the communication with ADC 210B are determined to be anomalous, VCIB 111 determines that an anomaly is occurring in the communication with ADK 200. Note that the VCIB 111 may determine that an anomaly is occurring in the communication with ADK 200 even upon receiving a signal different from the various signals typically receiving from ADK 200. If an anomaly is determined to be occurring in the communication with ADK 200 (YES in S104), the process proceeds to S106.

In S106, VCIB 111 determines whether vehicle 10 is in the autonomous driving mode. For example, if the vehicle mode state is the autonomous driving mode, VCIB 111 determines that the vehicle 10 is in the autonomous driving mode. For example, if the vehicle mode state is the manual operation mode, VCIB 111 determines that the vehicle 10 is not in the autonomous driving mode. If vehicle 10 is determined to be in the autonomous driving mode (YES in S106), the process proceeds to S108.

In S108, VCIB 111 notifies the user of information indicating that an anomaly has occurred in the autonomous driving system. VCIB 111 shows, on MID 112, text information and/or image information indicating that an anomaly has occurred in the autonomous driving system. Subsequently, the process ends. Note that if vehicle 10 is determined to be not in the autonomous driving mode (NO in S106), the process proceeds to S110.

In S110, VCIB 111 notifies the user of information indicating that the use of the autonomous driving system is not allowed. For example, VCIB 111 displays, on MID 112, text information and/or image information indicating that the use of the autonomous driving system is not allowed. Subsequently, the process ends. Note that if VCIB 111 determines that the ADK 200 is not mounted on vehicle 10 (NO in S100), the unit authentication is not completed in ADK 200 (NO in S102), or no communication anomaly is occurring with ADK 200 (NO in S104), the process ends.

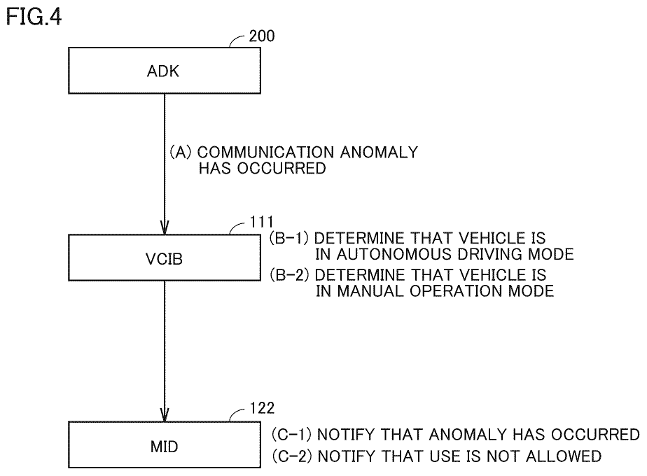

An operation of VCIB 111 based on the configuration and flowchart as described above is now described, with reference to FIG. 4. FIG. 4 is a diagram for illustrating an operation of VCIB 111.

In the following, assume that the vehicle 10 having ADK 200 mounted thereon and completed the unit authentication for ADK 200 is traveling in the autonomous driving mode.

Since VCIB 111 determines that the vehicle 10 has ADK 200 mounted thereon (YES in S100) and that the unit authentication is completed (YES in S102), VCIB 111 determines, while vehicle 10 is traveling, whether an anomaly is occurring in the communications between ADK 200 and VCIB 111 (S104).

As shown in (A) of FIG. 4, VCIB 111 determines that an anomaly is occurring in the communications between ADK 200 and VCIB 111 (YES in S104), VCIB 111 determines whether vehicle 10 is in the autonomous driving mode (S106). If VCIB 111 determines that the vehicle 10 is in the autonomous driving mode (YES in S106) as shown in (B-1) of FIG. 4, VCIB 111 notifies the user that an anomaly has occurred in the autonomous driving system as shown in (C-1) of FIG. 4 (S108). In other words, text information or image information indicating that the anomaly has occurred in the autonomous driving system is displayed on MID 112, and the user is, therefore, allowed to recognize, from the content of the notification, that the autonomous driving mode being selected cannot continue.

If VCIB 111 determines, in contrast, that an anomaly is occurring in the communications between ADK 200 and VCIB 111 (YES in S104) and that the vehicle 10 is in the manual operation mode (NO in S106) as shown in (B-2) of FIG. 4, VCIB 111 notifies the user that the use of the autonomous driving system is not allowed, as shown in (C-2) of FIG. 4 (S110). In other words, text information or image information indicating that the use of the autonomous driving system is not allowed is displayed on MID 112, and the user is, therefore, allowed to recognize, from the content of the notification, that the manual operation mode being selected cannot be switched to the autonomous driving mode.

As described above, according to vehicle 10 of the present embodiment, in the event of a communication anomaly with ADK 200, VCIB 111 notifies the user of different information during the autonomous driving mode and during the manual operation mode, thereby notifying the user of appropriate information upon a communication anomaly during the autonomous driving mode and upon a communication anomaly during the manual operation mode, respectively. In particular, when vehicle 10 is in the autonomous driving mode, the user is notified that an anomaly has occurred in the autonomous driving system, and the user is, therefore, allowed to recognize that the autonomous driving mode cannot continue. When vehicle 10 is in the manual operation mode, the user is notified that the use of the autonomous driving system is not allowed, and the user is, therefore, allowed to recognize, while vehicle 10 is in the manual operation mode, that the manual operation mode cannot be switched to the autonomous driving mode. Accordingly, the vehicle can be provided that can notify the user of appropriate information in the event of an anomaly in the communication with the autonomous driving system.

Furthermore, if the autonomous driving system is not mounted on vehicle 10 or the unit authentication is not completed, no determination is made as to whether a communication anomaly has occurred or not. Thus, a determination, due to the vehicle not having the autonomous driving system mounted thereon or the unit authentication being not completed, that a communication anomaly has occurred and providing the user with such a notification, can be reduced.

In the following, variations are described.

In the above-described embodiment, whether the communication between ADK 200 and VCIB 111 is anomalous is determined if the autonomous driving system is mounted on vehicle 10 and the unit authentication is completed. However, whether the communication between ADK 200 and VCIB 111 is anomalous may be determined if the unit authentication is completed, irrespective of whether the autonomous driving system is mounted on vehicle 10 or not. Alternatively, whether the communication between ADK 200 and VCIB 111 is anomalous may be determined if the autonomous driving system is mounted on vehicle 10, irrespective of whether the unit authentication is completed or not.

Furthermore, while the embodiment has been described above in which the MID 112 is used to provide the notifications to the user, by way of example, for example, a sound generating device may be used alternative to or in addition to the display device to provide the notifications, or the various notification devices included in base vehicle 100 may be used to provide the notifications to the user.

Note that all or some of the variations described above may be combined and implemented, as appropriate.

While the embodiment according to the present disclosure has been described above, the presently disclosed embodiment should be considered in all aspects illustrative and not restrictive. The scope of the present disclosure is defined by the appended claims. All changes which come within the meaning and range of equivalency of the appended claims are to be embraced within their scope.

What is claimed is:

1. A vehicle, comprising:
an autonomous driving system;
a vehicle platform that performs a vehicle control, according to a command from the autonomous driving system; and
a vehicle control interface that interfaces between the vehicle platform and the autonomous driving system, wherein
in an event of an anomaly in a communication between the autonomous driving system and the vehicle control interface during autonomous driving of the vehicle, the vehicle control interface notifies a user of first information, and
in an event of an anomaly in the communication during manual driving of the vehicle, the vehicle control interface notifies the user of second information different from the first information.

2. The vehicle according to claim 1, wherein
when the autonomous driving system is not mounted on the vehicle, the vehicle control interface does not determine whether an anomaly has occurred in the communication.

3. The vehicle according to claim 1, wherein
when a unit authentication for the autonomous driving system mounted on the vehicle is not completed, the vehicle control interface does not determine whether an anomaly has occurred in the communication, and
when the unit authentication is completed, the vehicle control interface determines whether an anomaly has occurred in the communication.

4. The vehicle according to claim 1, wherein
the first information includes information indicating that an anomaly has occurred in the autonomous driving system, and
the second information includes information indicating that use of the autonomous driving system is not allowed.
